(19) United States
(12) Patent Application Publication
(10) Pub. No.: US 2012/0223517 A1
(43) Pub. Date: Sep. 6, 2012

(54) TUBING AND CONNECTOR AND METHOD MAKING THE SAME

(75) Inventors: Martin Morrissey, Billerica, MA (US); Jeff Hartnett, West Roxbury, MA (US)

(73) Assignee: EMD Millipore Corporation, Billerica, MA (US)

(21) Appl. No.: 13/406,656

(22) Filed: Feb. 28, 2012

Related U.S. Application Data
(60) Provisional application No. 61/448,933, filed on Mar. 3, 2011.

(51) Int. Cl. F16L 41/00; B29C 45/14

(52) U.S. Cl. 285/125.1; 264/263

(57) ABSTRACT

The present invention is a device for fluid movement and method of making the same. The device has a core element comprised of a preformed barbed fitting having two or more barbed extensions. Each extension has a central bore connected to the central bores of the other extensions so as to provide fluid communications between them. A tube having a central bore is fitted over the barb of each extension. A molded housing is formed over the fitting and tubes to form the device

### CROSS-REFERENCED TO RELATED APPLICATION

This application claims the benefit of U.S. Provisional Patent Application No.: 61/448,933, filed on Mar. 3, 2011, the entire contents of which are incorporated by reference therein.

The present invention relates an integral connector and tube fitting. More particularly it relates to a disposable, integral connector and tube fitting for two or more tubings.

### BACKGROUND OF THE INVENTION

Traditional plastic connectors for three or more pieces of tubing has been to mold a separate plastic or metal fitting having three or more barbed extensions, each extension having a hollow bore therethrough and connecting to the bores of each of the other extensions, a plurality of tubing, each tubing having a hollow bore and each tubing mounted over the barb of each barbed extension and a device to mechanically hold the tubing to each extension such as a cable tie or a tubing locking device such as a Barblock®device. These devices have several issues. The security of the tubing connection to the barbed fitting is not always sufficient and the tubing can be dislodged during installation or use. Additionally, the seal by the mechanical device may not enclose the entire circumference which can lead to leakage.

Alternatively, one has used adhesives to bond the inner surface of the tubing to the extension and to keep the tubing over the barb. However adhesives are not generally acceptable as they can spread and either block off the tubing or provide extractable materials to the fluid that passes through the tubing.

More recently a new design and method has been used to make such a device by first molding the first and second extensions with their associated tubing by using a Y shaped removable core pin placed within the bore of the first and second tubings. The third portion of the Y shaped core pin has a removable mold insert over it. The assembly is placed in a specially designed mold to mold the first two extensions. The mold insert and the Y shaped core pin are removed with a pair of pliers. A third piece of tubing has a straight third portion core pin inserted into the bore such that a portion of the pin extends from each end of the third tubing piece. The semi finished connector with the third core pin is placed back into the mold and the third extension is molded over the third tubing and to the first and second extension. The connector is then removed from the specially designed mold and the core pin is removed to provide an integral connector having the bores of all three tubings in fluid communication with each other. See U.S. Pat. No. 6,290,265.

One limitation of this method is that at least the third tubing must be relatively short (i.e. if the tubing segments are extremely long, one can't easily put a core pin into the tubing bore nor remove it after molding). Another is that it requires the use of like materials so that they bond to each other during the molding. Moreover, the process is slow as it requires two steps to mold the device and the use of special molds and mold inserts.

The present invention provides a device and process for making it that overcomes the limitations of the prior art devices and methods.

### SUMMARY OF THE INVENTION

The present invention is a device for fluid movement and method of making the same. The device has a core element comprised of a preformed barbed fitting having two or more barbed extensions, preferably three or more extensions. Each extension has a central bore connected to the central bores of the other extensions so as to provide fluid communications between them. A tube having a central bore is fitted over the barb of each extension. A molded housing is formed over the fitting and tubes to form the device.

It is an object of the present invention to provide a tubular fitting for fluid comprising a barbed fitting having two or more barbed extensions, each extension having a hollow bore therethrough and connecting to the bores of each of the other extensions, a plurality of tubing, each tubing having a hollow bore and each tubing mounted over the barb of each barbed extension and an overmolded housing entrapping the barbed fitting and a portion of each tubing at least beyond the end of the barbed extensions.

It is another object of the present invention to provide a barbed fitting made of a plastic, such as thermoplastic or thermoset, or a metal.

It is a further object of the present invention to provide an overmolding formed of a plastic, such as a thermoplastic or a thermoset.

It is another object of the present invention to provide a method of making an integrated connector with two or more tubings extending from the connector comprising the steps of forming a barbed fitting having two or more barbed extensions, each extension having a hollow bore therethrough and connecting to the bores of each of the other extensions, sliding a tubing having a hollow bore over each barbed extension and overmolding a housing entrapping the barbed fitting and a portion of each tubing at least beyond the end of the barbed extensions.

### IN THE DRAWINGS

FIG. 1 shows a top down cross-sectional view of a fitting element useful in one embodiment of the present invention.

FIG. 2 shows a top down cross-sectional view of the fitting of FIG. 1 at an intermediate assembly stage.

FIG. 3 shows a cross sectional view of the molding stage of the first embodiment of the present invention.

FIG. 4 shows a top down cross-sectional view of one embodiment of an entire device of the present invention.

FIGS. 5A-D shows other embodiments of the entire device of the invention in a top down planar view.

FIG. 6 shows another embodiment of the present invention in top down cross sectional view.

### DETAILED SPECIFICATION

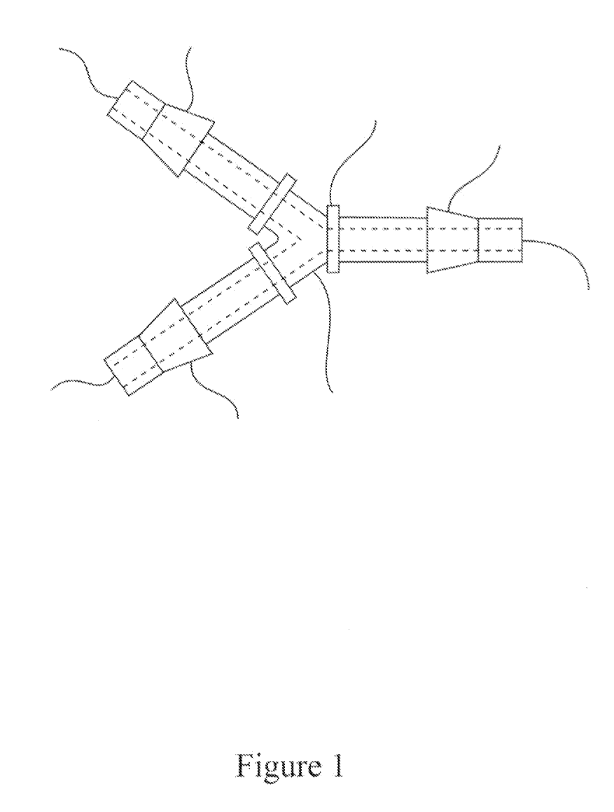

FIG. 1 shows a fitting component of an embodiment of the present invention. The fitting 2 is a barbed fitting 2 with two or more extensions 4A-C. As can be seen the fitting 2 has a central bore 10A-C that runs through each of the extensions 4A-C and which unite within the fitting 2 so that all of the extensions 4A-C and their bores 10A-C are in fluid communication with each other. In this embodiment, three extensions are shown, although additional extensions such as four, five, six or more extensions can be used as well.

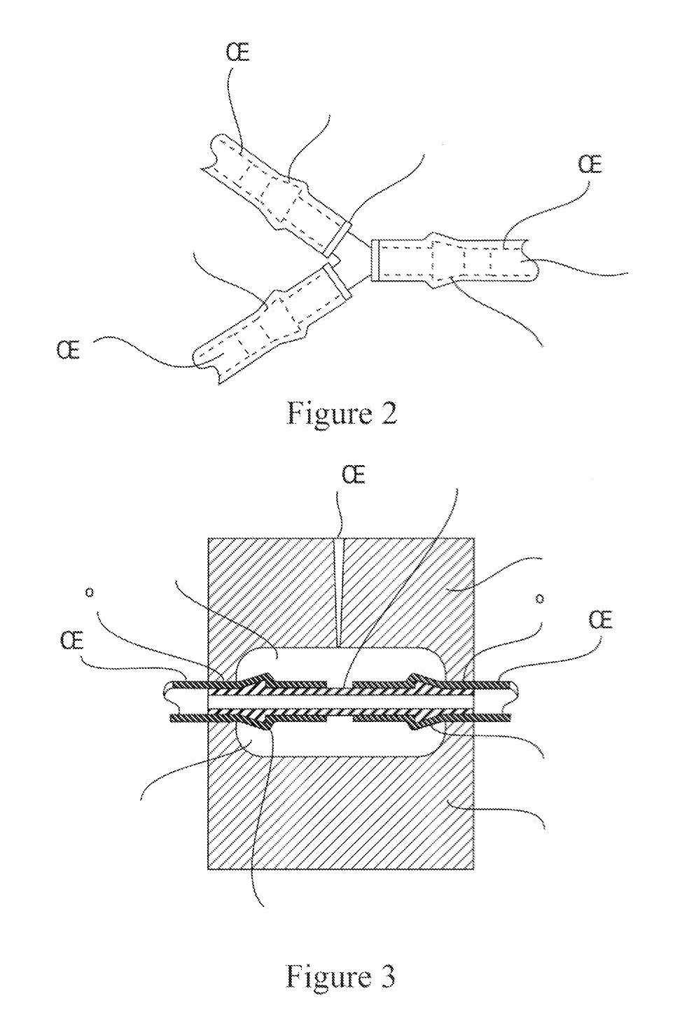

FIG. 2 shows an intermediate step of the formation of a device in which tubes 6A-C are fitted over the barbs of each extension 4A-C of the fitting 2 of FIG. 1 to hold the tubes in place. Each tube 6A, 6B and 6C has a bore 12 which is in alignment and fluid communication of the bore 10 of the fitting 2. Optionally one can use a tube stop 3 on one or more of the extensions 4 to control the amount of extension 4 that is covered by a tube 6.

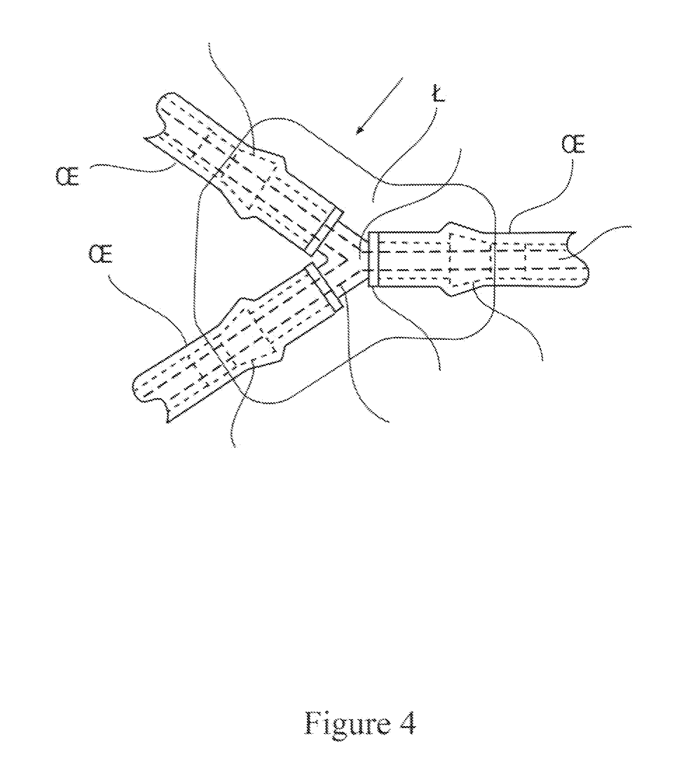

If desired, one can use an adhesive or heat bond (not shown) to further secure the tube over an extension. Alternatively, one can use a tie wrap or a locking mechanism such as a Barblock® device available from Saint Gobain to further secure the tube(s) 6 to the extension 4 barb(s) (not shown). In most cases however, these features are unnecessary as the overmolded cover 8 as explained in relation to FIG. 4 is more than sufficient to provide the necessary retention force.

FIG. 4 shows a finished device according tone embodiment of the present invention. The device 1 is formed of several components including a barbed fitting 2 with two or more extensions 4A-C, a tube 6A-C fitted over each extension 4A-C of the fitting 2 and an overmolded cover 8 that retains the fitting 2 and tubes 4A-C in place

FIG. 3 shows a mold 20, 22 in this instance a two piece mold, although a single piece mold with an open top or a multipiece (3 or more pieces) mold may also be used. The intermediate assembly comprised of the fitting 2 (in which extensions 4A and 4C are shown in cross sectional view) with their respective tubing 6A and 6C fit over the respective extensions 4A and 4C in this instance. The mold 20, 22 has a number of ports, 25, 27 equal in number to the number of extensions 4 that are on the fitting 2 in use. The mold 20, 22 also has a cavity 24 on both sides of the fitting 2 when the intermediate assembly is placed in the mold 20, 22. The cavity 24 is used to hold the molded cover 8 (of FIG. 4) as it is formed. Preferably the cover material enters through a cover material port 26. While one cover material port 26 is shown additional cover material ports may be used if desired or required to get the cover material in place before it sets in the mold 20, 22. As shown, the mold ports 25, 27 are substantially coterminous with the end of each extension 4 of the fitting 2 with in the mold 20, 22. It may also be short or long of the end of the extensions if desired.

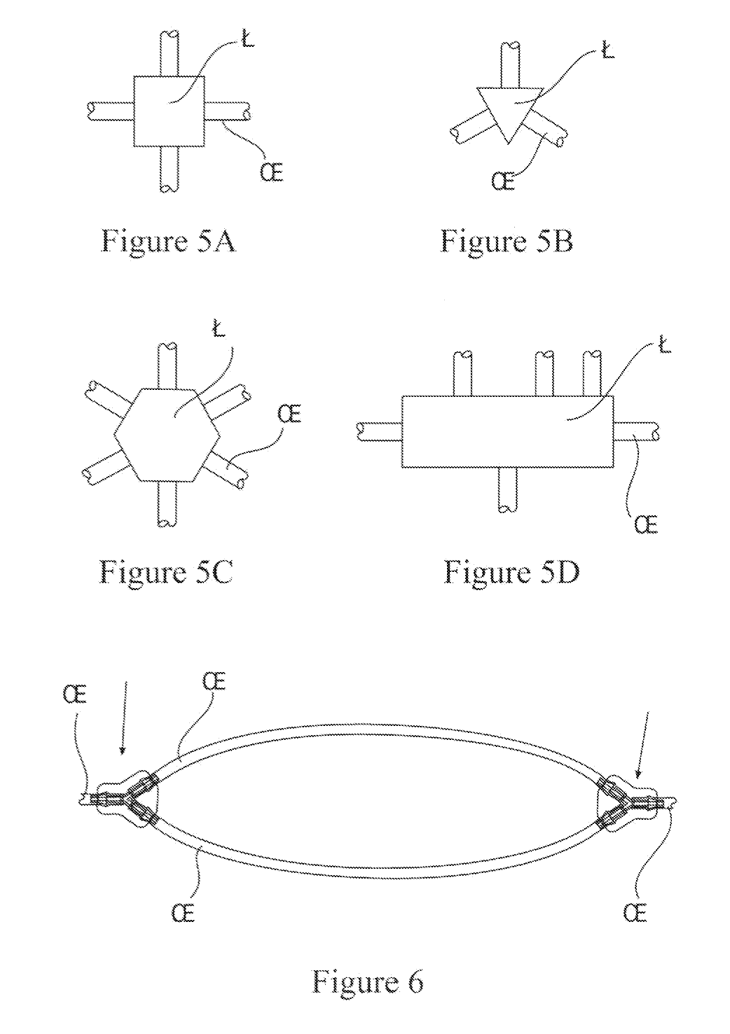

FIGS. 5A-D show some other designs that are possible with the present invention. For example, FIG. 5A shows a square cover 8A with four extensions. FIG. 5B shows a triangular design for the cover 8B and three extensions. Likewise FIG. 5C shows a hexagon design with six extensions and FIG. 5D shows a rectangular manifold design with six extensions. The shape of the overmolded cover 8 and the number of extensions are not limited by the invention and any design and number of extensions can be formed with the present invention.

FIG. 6 shows an assembly incorporating two of the devices 1 of the present invention. As can be seen each fitting 2 is a three extension fitting in this embodiment. Each fitting has a first tube 6A on one fitting of each device 1A and 1B and two tubes, 6A and 6B one each from the other two fittings of each device 1A and 1B.

A method of making the present invention is to first make a barbed fitting with the desired number of extensions arranged in the desired manner. The extensions may be of the same size (length and diameter) or different size if desired. Likewise they may be equally spaced apart from each other or spaced at different angles as the need or desire requires. For example, it is one preferred embodiment that the extensions be equally spaced apart, with an equal angle between and that they all be of the same length and diameter. Alternatively, one or more extensions can be a length different from the rest or the extensions are not equally spaced apart (for example in a manifold design one could have one extension on one side and two or more on the opposite side) or at least one has a different angle between it and at least one of its neighboring extensions as the other extensions.

The barbed fitting may be made of metal such as stainless steel or aluminum, a thermoplastic or a thermoset plastic such as epoxy. Preferably it is formed of metal or thermoplastic. More preferably it's formed of a thermoplastic such as polyethylene, polypropylene, polysulfone, polyethersulfone, polyarylsulfone, polyvinylidene fluoride, PTFE, polyether ether ketone and the like. Thermosets can be epoxy, silicone and ethylene-propylene diene monomers.

The tubes can be any generally used in the pharmaceutical or medical industry and include but are not limited to thermoplastic tubes such as those made of polyethylene or polypropylene; thermoset tubes such as silicone tubes or other specialty materials such as C-Flex® tubes and the like.

The cover material/overmolding/overmolded housing can be formed of a thermoplastic such as polyethylene, polypropylene, polysulfone, polyethersulfone, polyarylsulfone, polyvinylidene fluoride, PTFE, polyether ether ketone and the like or a thermoset plastic such as silicone, epoxy, polyurethane and ethylene-propylene diene monomers.

The silicone for the fitting and/or cover or overmolded housing may be room temperature, or moist curable or platinum or other metal based catalyst curable as is well known in the art.

It is preferred that the materials of the tubing and cover be compatible to form the most appropriate connection possible between each of the elements. All three elements including the fitting may be compatible with each other. In a further embodiment, all the components (fitting, tubing and cover) are formed of the same material and more preferably all are formed from a thermoplastic such as polyethylene or polypropylene or thermoset such as a silicone or polyurethane or epoxy.

Tubes are fit over each of the extensions such that the barb on each extension secures the tube in place. As mentioned above, one can add additional retention features such as welds, adhesives or mechanical devices to further secure the tubes in place. Optionally, one can use a tube stop 3 in lieu of or additionally to the optional retention features if desired. The bore of the fitting and each extension thereof is alignment with and fluid communication with the bore or lumen of each tube.

The tube/fitting subassembly is then molded with a cover 8. This can be accomplished in a mold if desired as explained in relation to FIG. 3 or it can be done simply on a surface provided the molding can cover all sides of the fitting/tube subassembly so as to securely hold the structure together under normal operating conditions.

In one preferred embodiment, the device is all formed of thermoplastic with a thermoplastic fitting 2, tubes 6 and cover 8. In this embodiment, the thermoplastic of each component may be the same or it may differ so long as they are compatible with each other. For example, one may use a thermoplastic with a higher melting point for at least the fitting 2 than the other components so that the fitting 2 doesn't collapse or distort when exposed to the molten thermoplastic of the cover during formation. Likewise one may select both the fitting and tubes be made of a thermoplastic with a higher melting point than that of the cover material to prevent collapse and/distortion.

In another embodiment, one can select a material for the tubing that at least softens when in the presence of the molten cover material so that one obtains a heat bond as well as a mechanical bond between at least the tube and the cover and preferably between the fitting, tube and cover.

In another preferred embodiment one can use a metal fitting with thermoplastic tubes and cover material.

In an additional preferred embodiment, one can use a metal, thermoset or plastic fitting with silicone tubes and cover material.

In a further embodiment, one can use a thermoset fitting such as an epoxy or urethane fitting with a thermoplastic or silicone tubes and a thermoset cover material.

As one can appreciate the combinations are extensive allowing one to select the best components for the desired application.

What I claim:

1) A method of making an integrated connector with two or more tubings extending from the connector comprising the steps of forming a barbed fitting having two or more barbed extensions, each extension having a hollow bore therethrough and connecting to the bores of each of the other extensions, sliding a tubing having a hollow bore over each barbed extension and overmolding a housing entrapping the barbed fitting and a portion of each tubing on the barbed extensions.

2) The method of claim 1 wherein overmolding is conducted using a molten thermoplastic.

3) The method of claim 1 wherein overmolding is conducted using a liquid thermoset.

4) The method of claim 1 wherein the overmolding is a thermoplastic.

5) The method of claim 1 wherein the overmolding is polypropylene.

6) The method of claim 1 wherein the overmolding is polyethylene.

7) The method of claim 1 wherein the overmolding is a thermoset selected from the group consisting of epoxy, polyurethane and silicone.

8) The method of claim 1 wherein the overmolding is silicone.

9) The method of claim 1 wherein the barbed fitting is selected from the group consisting of metal, thermoplastic and thermoset materials.

10) The method of claim 1 wherein the barbed fitting and the overmolding are of the same materials.

11) A tubular filling for fluid comprising a barbed filling having two or more barbed extensions, each extension having a hollow bore therethrough and connecting to the bores of each of the other extensions, a plurality of tubing, each tubing having a hollow bore and each tubing mounted over the barb of each barbed extension and an overmolded housing entrapping the barbed fitting and a portion of each tubing on the barbed extensions.

12) The fitting of claim 11 wherein the barbed fitting has three or more barbed extensions.

13) The fitting of claim 11 wherein the barbed fitting has extensions are at an angle equal to each other.

14) The fitting of claim 11 wherein the barbed fitting is selected from the group consisting of metal, thermoplastic and thermoset materials.

15) The fitting of claim 11 wherein the overmolded housing is a thermoset selected from the group consisting of epoxy, polyurethane and silicone.

16) The fitting of claim 11 wherein the overmolded housing is a thermoplastic selected from the group consisting of polyethylene, polypropylene, polysulfone, polyethersulfone, polyarylsulfone, polyvinylidene fluoride, PTFE, polyether ether ketone.

17) The fitting of claim 11 wherein the material of the tubing and the overmolded housing are compatible.

18) The fitting of claim 11 wherein the material of the tubing and the overmolded housing are the same.

19) The fitting of claim 11 wherein the material of the fitting, tubing and the overmolded housing are the same.
